(19) United States
(12) Patent Application Publication
(10) Pub. No.: US 2004/0175480 A1
(43) Pub. Date: Sep. 9, 2004

(54) Hop beta acid compositions for use in food products

(75) Inventors: Dennis L. Seman, Cottage Grove, WI (US); John Alfred Hirschey, Middleton, WI (US); Andrew L. Milkowski, Cottage Grove, WI (US); Michael Barney, Elm Grove, WI (US)

Correspondence Address: FITCH EVEN TABIN AND FLANNERY, 120 SOUTH LA SALLE STREET, SUITE 1600, CHICAGO, IL, 60603-3406, US

(73) Assignee: Kraft Foods Holdings, Inc.

(21) Appl. No.: 10/378,330

(22) Filed: Mar. 3, 2003

(51) Int. Cl. C12C 3/00

(52) U.S. Cl. 426/600

(57) ABSTRACT

Hop beta acids are improved with respect to their antibacterial properties, especially their anti-Listeria properties. Enhancement in this regard is especially useful for the treatment of food products which are susceptible to bacterial contamination. This can be especially important when the hop beta acids are to be used in surface application onto the food products. The hop beta acids are rendered more effective by combining them with a food grade acid, a potassium ion source, and an optional antioxidant in a carrier solvent such as, for example, a food grade alcohols or a food grade glycol. The improved hop beta acid compositions of this invention provide increase stability, higher hop beta acid concentrations, and/or higher anti-Listeria activities.

### FIELD OF THE INVENTION

This invention generally relates to improved hop beta acid compositions for use within food products. The improved hop beta acid compositions are especially useful in food products which are susceptible to detrimental bacterial or other microbiological action.

### BACKGROUND OF THE INVENTION

It is generally known that hop beta acids are useful for inhibition of food pathogens. It is known that hop beta acids have antibacterial activities and are useful in reducing the growth of Listeria and other bacteria in food products. Food pathogens, particularly Listeria monocytogenes (Lm), are known contaminants of food products such as meats, processed meats, and cheeses. Hops or hops extracts are well know as antimicrobial agents. See, e.g., U.S. Pat. No. 5,286,506 (Feb. 15, 1994; incorporation of about 6 to 50 ppm beta acids extracted from hops inhibit the growth of Listeria when applied to or combined with a food product); U.S. Pat. No. 5,455,038 (Oct. 3, 1995; use of tetrahydroisohumulone and/or hexahydrocolupulone at levels as low as 0.4 to 1.6 ppm for inhibiting Listeria); U.S. Pat. No. 6,251,461 (Jun. 26, 2001; about 1 to 100 ppm hop extract effective for inhibiting Clostridium botulinum, Clostridium difficile, and Helicobacter pylon); U.S. Pat. No. 6,379,720 (Apr. 30, 2002; use of about 0.01 to about 10,000 ppm hops extract to control biological fouling in water systems and process streams); and U.S. Pat. No. 6,451,365 (Sep. 17, 2002; use of hops acids and hops acid derivatives in combination with a gram positive bacteriostatic or bactericidal compound to control gram positive bacteria in food products).

Antioxidants are known to be useful for inhibition of food pathogens. U.S. Pat. No. 3,852,502 (Dec. 3, 1974) and U.S. Pat. No. 4,110,483 (Aug. 29, 1978), for example, used phenolic-type antioxidants, including butylated hydroxianisole (BHA), butylated hydroxytoluene (BHT), and tocopherols. The synergistic compositions combining phenolic-type antioxidants with autolyzed yeast protein solids or extracts from certain naturally occurring spices or herbs were described.

While hop beta acids are believed to have substantial potential in reducing the growth of Listeria and other bacteria in food products, such has not reached its full potential because of the very short shelf life of hop beta acids and hop beta acid extracts and/or the low levels of hop beta acids and hop beta acid extracts normally used in food applications. A typical maximum shelf life is on the order of about a month. When it comes to commercially distributed and processed food products, they must remain wholesome for the duration of distribution, warehousing, storage and commercial display time periods. The total of these time periods typically required for commercial retailed packaged foods results in a total time constraint which approaches, and more often exceeds, the maximum shelf life of hop beta acids or hop beta acid extracts. Another difficulty which has seriously hampered the ability to use hop beta acids in commercial food distribution channels is the problem that the efficacy of the hop beta acids decreases over time, resulting in variations in potency over a relatively short time period. Such variations cannot be compensated for easily without the use of costly and time-consuming assays of stored hop extracts. Accordingly, the relatively short storage time for hop beta acids and the variations in antimicrobial activity which is experienced over time have hampered an effective realization of the full potential of hop beta acid products.

Although antioxidants per se long have been known for use in conjunction with food supplies, heretofore no viable connection has been made between particular antioxidants and their usefulness in conjunction with beta acids from hops. Nor have other methods been advanced for increasing the stability of such antimicrobial agents. Significant advantages could be realized by stabilizing hop beta acids and making them less susceptible to the rapid loss of effectiveness against Listeria and other bacteria in food products. Heretofore, there has not been a recognition that certain antioxidants are important and useful in stabilizing hop beta acid products and making them more useful in commercial food operations.

Thus, it would be desirable to provide an improved method for imparting antibacterial and/or antimicrobial activity, especially Listeria-resisting activity, to food supplies for commercial channels of trade. It would also be desirable to provide Listeria protection in an simplified manner and without requiring costly and time-consuming assays of hops extracts. It would also be desirable to provide hops-originating beta acids with a shelf life on the order of at least six months and which are suitable for use in food products. It would also be desirable to provide hop beta acid compositions which have enhanced storage shelf lives, thereby making them more useful for operations in commercial food production. It would also be desirable to provide hop beta acid compositions which have more effective antimicrobial activities and especially more effective anti-Listeria activities for use in food products. The present invention provides such methods and compositions.

### SUMMARY OF THE INVENTION

In accordance with the present invention, improved hop beta acid compositions which contain a stabilized and/or more effective form of hop beta acids are provided. The improved hop beta acid compositions of this invention contain hop beta acids, food grade organic acids, a soluble source of potassium ions (e.g., potassium salts of food grade organic acids), and an optional antioxidant in a carrier solvent (i.e., low molecular weight food grade alcohols and/or glycols). Preferably, the improved hop beta acid compositions contains the optional antioxidants which appears to contribute to increased stability of the compositions. Preferably, the antioxidants are natural antioxidants. The improved hop beta acid compositions of this invention containing antioxidants generally maintain their efficacy for time periods on the order of about six months to one year and generally have better antimicrobial activity (relative to hop beta acids alone) especially with regard to Listeria. Examples of antioxidants suitable for this purpose include rosemary extracts, ascorbic acid, rosemary extract acids such as carnosic acid, propyl gallate, and the like; preferably, natural antioxidants are used. Such improved hop beta acid compositions are useful in imparting improved antibacterial activity to food products, especially products having a relatively high water activity including cooked or uncooked meat products, cheeses, and the like. Food products containing such improved hop extract acid compositions have Listeria protection to impart an extra level of protection to food supplies incorporating the improved hop beta acid compositions.

The present invention provides an improved hop beta acid composition comprising a hop beta acid, a food grade organic acid, a soluble potassium ion source, and an optional antioxidant in a carrier solvent, wherein the carrier solvent comprises a food grade alcohol, a food grade glycol, or mixtures thereof. Preferably the antioxidant is included in the composition since it appears to stabilize the compositions and provides a longer shelf life. The inclusion of the food grade acid provides a lower pH condition on the food surfaces and, although not wishing to be limited by theory, may increase the efficiencies of the hop beta acids by keeping them in a protonated form.

Although it is generally preferred that the actual antimicrobial solution that is to be applied to the food product contain the potassium ion source, the potassium ion source can be applied separately to the food product or may be contained on or near the surfaces of the food product whereby the combined effects of the antimicrobial solution and the potassium ions are obtained when the antimicrobial solution is applied to the food product. Although not wishing to be limited by theory, it is thought that the potassium ions affects ion transport across the bacterial cell membrane (i.e., more efficient ion shuttling across the membrane) resulting in depletion of essential internal cellular ions within the bacterial cells and/or otherwise weaken the bacterial cell membrane so that the other components of the antimicrobial solution can more easily or effectively attack the microorganisms. The use of a carrier solvent comprising a food grade alcohol, a food grade glycol, or mixtures thereof allows improved solubility of the hop beta acids thus allowing higher concentrations to be used. Additionally, the carrier solvent appears to provide improved distribution of the hop beta acids over the outer surfaces of the food products to be treated.

In one embodiment, the present invention also provides an improved hop beta acid composition comprising about 0.1 to about 4 percent of a hop beta extract, about 0.1 to about 10 percent of a first food grade organic acid, about 0.1 to about 20 percent of a soluble potassium ion source, 0 to about 10 percent of a food grade antioxidant, and about 50 to about 95 percent of a carrier solvent comprising a food grade alcohol, a food grade glycol, or mixtures thereof. Preferably, especially where the hop beta acid composition may be exposed to light and/or air, the food grade antioxidant is included in the composition. Preferably the soluble potassium ion source is a potassium salt of a second food grade organic acid which is soluble in the carrier solvent.

An especially preferred hop beta acid composition comprises about 0.1 to about 4 percent of a hop beta extract, about 0.1 to about 10 percent of a first food grade organic acid, about 4 to about 20 percent of a soluble potassium ion source, about 0.1 to about 10 percent of a food grade antioxidant, and about 50 to about 95 percent of a carrier solvent comprising a food grade alcohol, a food grade glycol, or mixtures thereof. Preferably the soluble potassium ion source is a potassium salt of a second food grade organic acid which is soluble in the carrier solvent.

The present invention also provides a method for inhibiting antimicrobial growth in a food product, said method comprising applying an effective amount of a hop beta acid composition to the food product and sealing the food product and the hop beta acid composition in a package, wherein the hop beta acid composition comprises a hop beta acid, a first food grade organic acid, a soluble potassium ion source, and an optional food grade antioxidant in a carrier solvent, wherein the carrier solvent comprises a food grade alcohol, a food grade glycol, or mixtures thereof. Preferably the food grade antioxidant is included in the composition and the soluble potassium ion source is a soluble potassium salt of a second food grade organic acid.

### BRIEF DESCRIPTION OF THE DRAWINGS

FIG. 1 is a graphical representation of the data of Example 1 showing relative changes in hop beta acid recovery and anti-Listeria activity for various compositions.

FIG. 2 is a graphical representation of the data of Example 2 showing the effects of various treatments on hop beta acid concentration and anti-Listeria activity.

### DETAILED DESCRIPTION

Food products which can be enhanced in terms of protection from Listeria development according to the invention are those having significant water levels which enhance the hosting of bacteria including those from the Listeria species, including Listeria monocytogenes. Food products which are especially benefitted by the invention are meats (i.e., meat, poultry, seafood, and the like), processed meat products, and cheeses. This invention is especially directed towards providing antimicrobial protection for sausage products, wieners or hot dogs, luncheon meats, poultry, seafood, soft cheeses, pate, and the like. Antibacterial and anti-Listeria attributes can be imparted to these by use of the hop beta acid compositions according to the invention.

The hop beta acids or hop beta acid extract used in the present invention are generally available from commercial suppliers such as Watertown Hops (Watertown, Wis.). Especially preferred hop beta acids and/or hop beta acid extracts include those described in U.S. Pat. No. 5,286,506 (Feb. 15, 1994), which is hereby incorporated by reference.

The antibacterial compositions of this invention are prepared by simply mixing the components together in a suitable carrier solvent. Although it is generally preferred that actual antimicrobial solution that is to be applied to the food product contain the potassium ion source, the potassium ion source can be applied separately to the food product or may be contained on or near the surfaces of the food product whereby the combined effects of the antimicrobial solution and the potassium ions are obtained when the antimicrobial solution is applied to the food product.

Procedures for extracting beta acids from hop products are generally known. It has been found that certain natural components can be added to such hop beta acids if the proper medium is used. Media which can be used include short-chain alcohols and multi-hydroxy compounds especially glycols such as propylene glycol, as well as mixtures thereof. The medium may also contain water (preferably less than about 10 percent) in addition to the alcohols and/or glycols. Hop beta acids prepared chemically, isolated from hop beta acid compositions or extracts, or hop beta acid extracts themselves may be used in the present invention. Generally, hop beta acid extracts, especially those described in U.S. Pat. No. 5,286,506 (Feb. 15, 1994), are preferred.

Stabilizers for the hop beta acids include a first food grade acid and optional antioxidants. Suitable first food grade acids include lactic acid, acetic acid, propionic acid, citric acid, and the like as well as mixtures thereof. Although not wishing to be limited by theory, the food grade acid appears to provide a lower pH condition on the food surfaces which may increase the efficiencies of the hop beta acids by keeping them in a protonated form. Especially preferred antioxidants include so-called natural antioxidants, including extracts from certain spices or herbs. Such antioxidants are especially preferred when the improved hop beta acid composition is expected to be exposed to light and/or air. Suitable antioxidants include, for example, rosemary extracts, carnosic acid, rosmarinic acid, ascorbic acid, and the like. A preferred natural antioxidant is a rosemary extract. These are available commercially from suppliers such as Hauser Inc. (Long Beach, Calif.).

An especially preferred natural antioxidant for use in the present invention is the rosemary extract StabilEnhance™ from Hauser Inc. Typically, these are provided in oil soluble varieties and in water soluble varieties. Specific examples include Hauser oil soluble rosemary extract StabilEnhance™ No. 1280 and Hauser water soluble rosemary extract StabilEnhance™ No. 2411. The former is generally known as an OSR Liquid, and the latter is known as a WSR Liquid. The OSR Liquid contains about 5 percent carnosic acid, and the WSR Liquid contains about 4 percent rosemarinic acid. Besides carnosic acid and rosmarinic acid, another natural antioxidant food grade acid which has been found to be suitable to maintain the bactericidal capability of hop beta acids is ascorbic acid. Ascorbic acid or Vitamin C is a naturally occurring antioxidant component. Propyl gallate, although not a natural antioxidant, also can be useful in enhancing the viability of hop beta acids. This gallic acid propyl ester is of greater benefit to achieving the present objects than widely used synthetic antioxidants such as butylated hydroxyanisole, butylated hydroxy toluene, and tert-butyl hydroquinone.

The soluble potassium ion source may be an inorganic or organic potassium salt so long as it is sufficiently soluble to effectively provide at least about 0.3 M potassium ions in the carrier solvent. If the potassium ion source is external to the antimicrobial solution (e.g., applied separately or included in the food product), the effective concentration should provide an equivalent amount of potassium ions. Preferably, the soluble potassium ion source provides about 0.3 to about 0.6 M potassium ions. Suitable inorganic potassium salts include, for example, potassium chloride, potassium phosphate, potassium polyphosphate, potassium sulfate, and the like as well as mixtures thereof. Suitable organic potassium salts include potassium salts of food grade organic acids such as potassium lactate, potassium acetate, and the like as well as mixtures thereof. The most preferred soluble potassium ion source is potassium lactate.

The antimicrobial solution of this invention in prepared using a suitable low molecular weight food grade carrier or solvent. Such food grade carriers include, for example, short chain alcohols (C₁ to C₄) such as ethanol, compounds having multiple hydroxyl groups such as glycols, and mixtures thereof. An especially preferred carrier is propylene glycol. The carrier may also contain water; typically, such water is not added directly to the composition but rather is derived from other components such as, for example, commercial lactic acid or potassium lactate which normally contain water. Water, whether added directly or included via other components, generally should be less than about 10 percent of the antimicrobial solution. Generally, the carrier will constitute between about 50 and about 95 percent, and more preferably about 85 to about 95 percent, of the composition applied to food in order to control Listeria species.

Of course, other functional ingredients can be incorporated into the antimicrobial solution if desired to improve flow characteristics, wetting ability, adherence to the food surfaces, and the like so long as they are soluble in the antimicrobial solution and do not adversely affect either the antimicrobial activity of the antimicrobial solution or the organoleptic properties of the resulting food products. For example, 0 to about 2 percent of a monoglyceride can be incorporated into the antimicrobial solution in order to improve the effectiveness of the antimicrobial solution. Preferably the monoglyceride is present at about 0.05 to about 2 percent. Suitable monoglycerides include monolaurin, glyceryl monooleate, and the like as well as mixtures thereof, with monolaurin being preferred.

Any suitable manner of applying the improved compositions of this invention to the food product can be used. Examples of such methods include mixing the improved hop beta acid composition with the food product, injecting the improved hop beta acid composition into the food product, spreading the improved hop beta acid composition onto the outer surfaces of the food product, dipping the food product into the improved hop beta acid composition, spraying the food product with the improved hop beta acid composition, including the improved hop beta acid composition in a package with the food product such that the improved hop beta acid composition effectively covers the outer surfaces of the food product, and the like.

Compositions according to the invention have been observed to be useful in maintaining the advantageous anti-Listeria activity of hop beta acids. This has made possible the use of hop beta acids as an anti-Listeria agent for surface application to processed meat products, such as wieners. It has been found that the ability of the hop beta acids to consistently kill Listeria species heretofore had not been evident on the surfaces of such processed meat products, but such is accomplished with the present invention. Although not bound by any theory, it is postulated that the compositions according to the invention significantly retard the oxidation of lupulones to hulapones, it being generally known that, once thus oxidized, the bacteriostatic and bactericidal activities of hop beta acids diminish dramatically.

The following examples illustrate the efficacy of the present invention and of the present compositions and are not intended to limit the invention as claimed. Unless noted otherwise, all percentages are by weight. All patents, publications, and the like cited herein are incorporated by reference.

### EXAMPLE 1.

Stock solutions containing 10,000 ppm hop beta acids (Watertown Hops) were prepared by weighing 0.1 gram of beta acids into a vessel and adding 9.9 ml of a carrier (propylene glycol or ethanol). Heating was carried out in a water bath at 150° F., with mixing being carried out with a vortex mixer until the beta acids were dissolved. The stock solution was diluted 1:10 in the desired carrier to provide a 1000 ppm beta acid composition.

Certain of these beta acid compositions were combined with a 1000 ppm antioxidant component. In these compositions containing antioxidants, the antioxidant was mixed with the hop beta acid and the amount of carrier was reduced by an equal amount. The following antioxidant-containing compositions were prepared: (a) 1000 ppm beta acids with 1000 ppm ascorbic acid in a propylene glycol carrier; (b) 1000 ppm hop beta acids with 1000 ppm OSR Liquid (StabilEnhance #1280) in a propylene glycol carrier; and (c) 1000 ppm hop beta acids with 1000 ppm of an antioxidant (Tenox A; 40% butylated hydroxyanisole (BHA)), 8% citric acid, and 52% propylene glycol carrier.

The solutions were split into two equal portions. One portion was stored in foil-wrapped tubes in a laboratory refrigerator at about 4° C. for 10 days; the second portion was stored in a lighted refrigerated display case (about 100 foot candle light intensity) for five days and then in the laboratory refrigerator for an additional five days.

The samples were then analyzed by high performance liquid chromatography (HPLC) using the following conditions: a Zorbax C18 column of 250 mm and 4.6 mm internal diameter; mobile phase A—methanol; mobile phase B—20:80 methanol:water with 0.1% phosphoric acid; flow—85% A at 1 milliliter per minute; ambient temperature; and detector at 280 nm.

Two peaks were observed. They were of hop beta acid congers, that is aldupulone, colupulone, and lupulone. These two peak areas were averaged together. The peak areas of the samples which had been subjected to the light exposure were divided by the areas of the same sample which had been stored in the dark. The dark storage areas of each sample represented the percent of the initial amount of hop beta acids which were not oxidized and converted to hulapone.

A well diffusion assay was conducted by adding 40 microliters of each test solution into a well having a diameter of 0.9 cm. This well had been cut into the center of a petri dish filled with TSAYE agar which previously had been inoculated with Listeria monocytogenes cultures. Plates were incubated for 24 hours at 30° C. Zones of clearing were measured in two dimensions and reported in centimeters. The area of each zone of clearing was calculated and adjusted by subtracting the area of the well. The area of the samples which had been subjected to light exposure was divided by the area of the samples stored in the dark. The resulting value represented the relative amount of anti-Listeria activity retained in the sample.

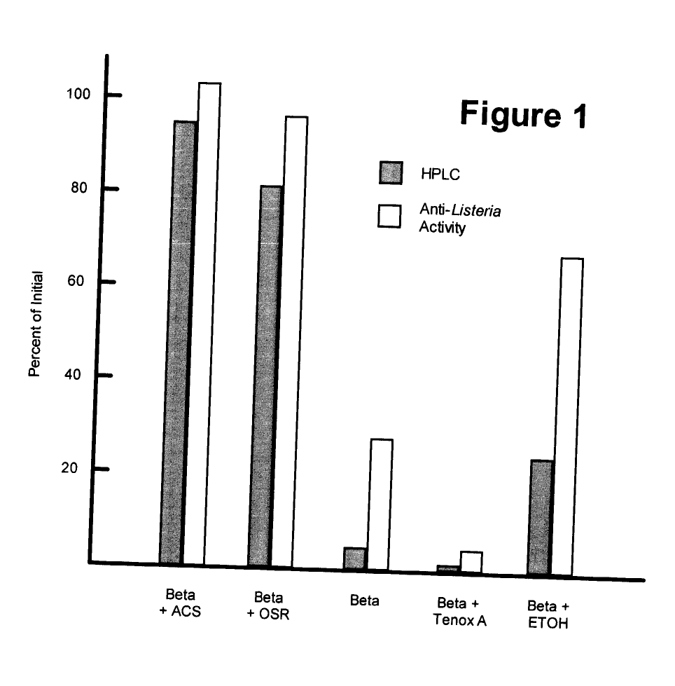

It was observed that both the HPLC and diffusion assays worked in this testing. In addition, it was observed that ethanol and propylene glycol did not confer any anti-Listeria activity by themselves. Data for the hop beta acids combined with ascorbic acid, OSR Liquid, and the synthetic antioxidant Tenox A are reported in FIG. 1. These data represent the relative changes in the amount of the beta acids recovered using the HPLC assay and the change in the area of clearing obtained from the well diffusion assay.

The observed decrease in recoverable hop beta acids is believed to be due to their oxidation to hulapones, although no corresponding new peaks were actually found. From this, it is understood that the exposure of the hop beta acids to light for 10 days does cause their oxidation. Notably, these data indicate that this oxidation is substantially reduced by the use of the natural antioxidants. The use of the synthetic antioxidant (i.e., Tenox A) did not provide much protection from deterioration of anti-Listeria activity. Significant amounts of oxidation also appeared when ethanol was used without an antioxidant.

In addition, the data of FIG. 1 indicate that the ability of hop beta acids to form a clear zone in the well diffusion test decreased after exposure to light. This provided confirmation that the hulapones have a diminished ability to kill Listeria. The data further indicate that the ability of the hop beta acids to kill Listeria was protected when either ascorbic acid or carnosic acid was applied, while the synthetic antioxidant Tenox A did not maintain the bactericidal capability of the hop beta acids. It can be concluded that the photo-oxidation of hop beta acids resulted in a diminished ability to kill Listeria, while the addition of the tested natural antioxidants reduced the effects of photo-oxidation of the hop beta acids and maintained a relatively high efficacy against Listeria.

In general, this testing indicated that hops beta acids are liable to photo-oxidation in as little as five days under commercial display light conditions. Also indicated is that both the amount of beta acids recovered (using HPLC) and the anti-Listeria activity conferred by the beta acids can be conserved by the use of ascorbic acid and StabilEnhance OSR liquid (oil soluble rosemary extract containing carnosic acid. The use of a commercially available synthetic antioxidant (Tenox A) did not significantly conserve either the beta acids or their anti-Listeria activity.

### EXAMPLE 2.

The procedures followed in Example 1 to prepare the beta acids were used to prepare the beta acid solutions shown in Table 1.

TABLE 1

| Description of | Hop Beta | Antioxidant | Propylene |
|---|---|---|---|
| Treatment | Acid (g) | amount | glycol (g) |
| Control | 0.1 | 0 | 9.9 |
| Ascorbic Acid | 0.1 | 0.005 g | 9.8 |
| Ascorbic Acid | 0.1 | 0.1 g | 9.8 |
| Ascorbic Acid | 0.1 | 0.2 g | 9.7 |
| 0SR | 0.1 | 100 μl | 9.8 |
| WSR | 0.1 | 100 μl | 9.8 |
| Tenox 7 | 0.1 | 100 μl | 9.8 |
| Tenox 20 | 0.1 | 100 μl | 9.8 |
| Tenox 22 | 0.1 | 100 μl | 9.8 |
| Tenox S-1 | 0.1 | 100 μl | 9.8 |
| Tenox A | 0.1 | 100 μl | 9.8 |
| Tenox 4 | 0.1 | 100 μl | 9.8 |

For each treatment, the total solution was 10 mL. In Table I, OSR refers to StabilEnhance OSR liquid #1280, and WSR refers to StabilEnhance WSR liquid #2411.

The composition of the Tenox antioxidants are listed in Table 2. Except for Tenox 4, all Tenox solutions used propylene glycol as a carrier.

| | | Tenox | Tenox | Tenox | Tenox | |
|---|---|---|---|---|---|---|
| Ingredient | Tenox 7 | 20 | 22 | S-1 | A | Tenox 4 |
| BHA | 28 | | 20 | | 40 | 20 |
| BHT | | | | | | 20 |
| TBHQ | | 20 | 6 | | | |
| Propyl gallate | 12 | | | 20 | | |
| Critic Acid | 6 | 10 | 4 | 10 | 8 | |
| Glycerol | 20 | | | | | |
| monooleate | | | | | | |
| Propylene | 34 | 70 | 70 | 70 | 52 | |
| glycol | | | | | | |
| Vegetable | | | | | | 60 |
| oil | | | | | | |

Each 10-mL tube of test solution was split into two 5-mL portions. One 5-mL portion was stored in foil-wrapped (capped) test tubes and stored in a refrigerator at 4° C. The other 5-mL portion was stored in capped test tubes in a lighted display case (ca. 100-foot candles) at approximately 4° C. Both sets of tubes were stored for 12 days. The concentration of hop beta acids and their antibacterial activity were measured on the initial day of storage and after 12 days of storage. The solutions were analyzed using HPLC and a well diffusion assay as in Example 1. The well diffusion test differed from the former in that the well was smaller (0.4 cm diameter). The agar used for the initial samples (day=0) was BHI and the media used for the 12 day samples was plate count agar.

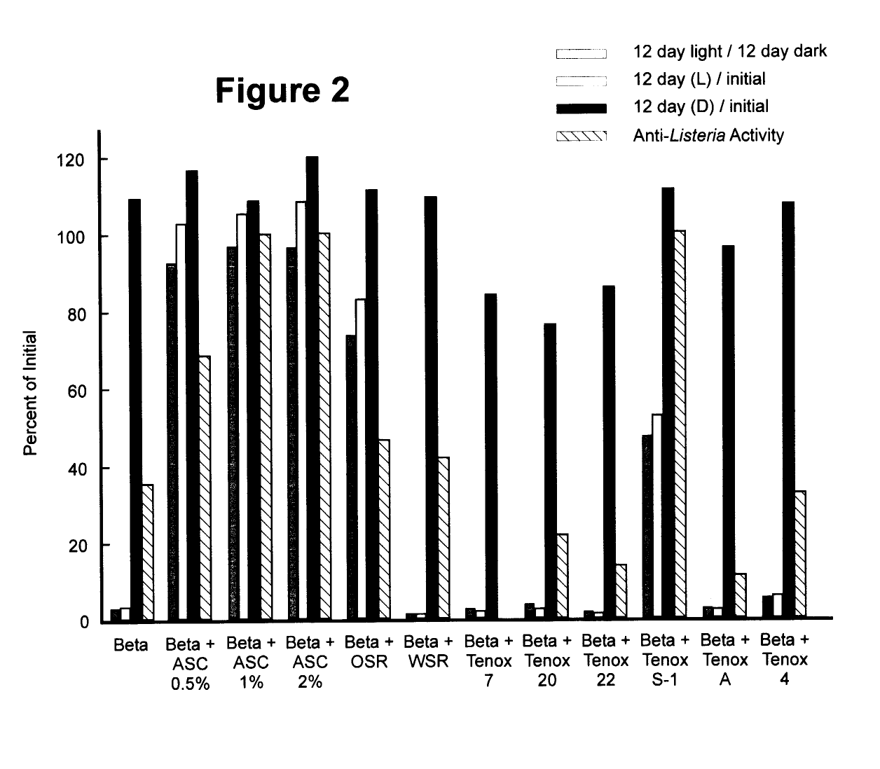

FIG. 2 shows the changes in content of hop beta acids and their anti-Listeria activities. The bars in the leftmost column indicate the effect of storage for 12 days on the oxidation of hop beta acids. Its legend, “12 day light/12 day dark”, indicates the amount of beta acids remaining after exposure to light for 12 days calculated as a percentage of the beta acids held in the dark for 12 days. Only 3% of the hop beta acids were recovered after 12 days of storage in the light. The addition of ascorbic acid resulted in relatively high amounts of recovered beta acids. Tenox S-1 (containing a substantial amount of propyl gallate and no BHA, BHT or TBHQ) exhibited over 40% recovery in beta acids. The remaining Tenox solutions did not confer any significant antioxidant activity sufficient to spare the beta acids. The anti-Listeria activity data (bars in the rightmost column) indicate that the ability of the beta acids to kill Listeria was also diminished by exposure to light for 12 days for the beta acids alone. The anti-Listeria activity was also spared when ascorbic acid and Tenox S-1 were used as an antioxidant. The other Tenox compounds did not retain much anti-Listeria activity.

The second bars indicate the effect of time on hops beta acids content. Its legend is “12 day (L)/initial.” These data show that the beta acid content decreased after 12 days of exposure to light and very closely correlated to the values in the first column. The third bars (“12 day (D)/initial”) show the effect of storage for 12 days of foil-wrapped tubes; this indicates that little beta acid oxidation took place when samples were stored in the dark. The values fluctuated from 76% to over 100% of the initial beta acid content. Possibly the beta acid content for the 12-day-old samples stored in the dark exceeded that of the initial amount because of possible variation in the preparation of the analytical standard or because of a slight evaporation of the propylene glycol solvent during the storage time.

No corresponding peaks identified as hulapones were observed. The data still strongly indicated that the photo-oxidation of hop beta acids was possible and that the photo-oxidation of the beta acids resulted in a diminished ability of the beta acids to kill Listeria species. These data indicate that photo-oxidation can be reduced by the use of ascorbic acid and Tenox-S1. The OSR liquid also exhibited antioxidant activity. Synthetic antioxidants such as Tenox A showed little ability to prevent loss of anti-Listeria activity. Ascorbic acid used at 0.5% resulted in less anti-Listeria activity than when it was used at 1% and 2%.

### EXAMPLE 3.

An antimicrobial solution containing about 0.3M lactic acid, about 0.3M potassium ion (in the form of potassium lactate), and about 20,000 ppm hop beta acids in propylene glycol was evaluated in challenge studies with packaged wieners using a six-strain cocktail of L. monocytogenes. Commercially available wieners were placed into pre-formed heat sealable pouches (4 per pouch). A L. monocytogenes culture was inoculated onto the smooth middle surface of the wieners to achieve about 1×10² CFU/package or about 1×10⁴ CFU/package, respectively. Antimicrobial solution (1.5 or 2.0 ml) was added to the bottom of the pre-formed pouch and the pouches were vacuum sealed. Samples were held for 24 hours to 7 days at 4° C. and then analyzed for the presence of L. monocytogenes by direct plating onto plate count agar and MOX (Modified Oxford Medium) plates. Colonies producing a black precipitate on the plates were considered positive for L. monocytogenes. Additionally, a modified USDA cultural method was performed. More details of these test methods can be found in Microbiology Laboratory Guidebook, USDA, 3rd Ed., Chapter 8, Revision 3 (1998), which is hereby incorporated by reference.

The results for the 1.4×10² CFU/package inoculum were as follows:

| Treatment | | | |
|---|---|---|---|
| (ml added, hours | TPC | MOX | |
| at 4° C.) | (CFU/package) | (CFU/package) | USDA |
| 1.5 ml - 24 h | <50 for 3 samples | 100, <50, <50 | 3 of 3 samples |
| | | | negative |
| 1.5 ml - 7 days | <50 for 3 samples | 100, 50, <50 | 2 of 3 samples |
| | | | negative |
| 2.0 ml - 24 h | <50 for 3 samples | <50 for 3 samples | 3 of 3 samples |
| | | | negative |
| 2.0 ml - 7 days | <50 for 3 samples | <50 for 3 samples | 3 of 3 samples |
| | | | negative |

The results for the 2.0×10⁴ CFU/package inoculum were as follows:

| Treatment | | | |
|---|---|---|---|
| (ml added, hours | TPC | MOX | |
| held at 4° C.) | (CFU/package) | (CFU/package) | USDA |
| 1.5 ml - 24 h | <50 for 3 samples | 350, 1050, 900 | 2 of 3 samples |
| | | | negative |
| 1.5 ml - 7 days | 50, 300, 750 | 1950, 2950, 1500 | 1 of 3 samples |
| | | | negative |
| 2.0 ml - 24 h | <50, <50, 2400 | 50, 100, 2850 | 3 of 3 samples |
| | | | negative |
| 2.0 ml - 7 days | <50, <50, 200 | 2250, 1050, 1300 | 3 of 3 samples |
| | | | negative |

Applying 2.0 ml of antimicrobial solution eliminated 1.4×10² CFU of L. monocytogenes within 24 hours. Applying 1.5 ml did not eliminate 1.4×10² CFU of L. monocytogenes even after 7 days. Challenging 2×10⁴ CFU L. monocytogenes with 2.0 ml of antimicrobial solution yielded USDA negative enrichments after 24 h and 7 days. It is noted, however, that MOX plate counts were present and these colonies could be, but were not confirmed as being, L. monocytogenes.

### EXAMPLE 4.

The challenge study of Example 3 was repeated using essentially the same antimicrobial solution except that the amount of the hop beta acids were varied (i.e., 15,000 ppm, 20,000 ppm, or 27,000 ppm) and both dry and wet wieners were used. For experiments with dry wieners, the wieners were dried using a paper towel prior to inoculation. Additionally, a separate trial was conducted wherein wieners were dipped into an antimicrobial solution containing 20,000 ppm hop beta acids, 0.3M lactic acid, and 0.3M potassium lactate in propylene glycol. An inoculum about 2×10⁴ CFU/package L. Monocytogenes was used. Samples were held for 24 hours at 4° C. before microbiological testing.

The following results were obtained:

| | | MOX (CFU/ | |
|---|---|---|---|
| | Total Plate Count | package/+ or − for | |
| Treatment | (CFU/package) | L. mono^{a} | USDA |
| Dry hotdog | <50 for 3 samples | 600/+ | Neg. |
| 1.5 ml of 20,000 ppm | | 250/ND^{b} | Pos. |
| | | 100/ND | Neg. |
| Dry hotdog | <50 for 3 samples | 50/+ | Neg. |
| 2.0 ml of 15,000 ppm | | 50/+ | Neg. |
| | | 700/+ | Pos. |
| Dry hotdog | <50 for 3 samples | <50/+^{c} | Neg. |
| 2.0 ml of 20,000 ppm | | 100/+ | Neg. |
| | | 50/+ | Neg. |
| Wet hotdog | <50 for 3 samples | 1500/ND | Neg. |
| 1.5 ml of 20,000 ppm | | 850/+ | Neg. |
| | | 150/ND | Pos. |
| Wet hotdog | <50 for 3 samples | <50/+^{c} | Neg. |
| 2.0 ml of 20,000 ppm | | 100/+ | Neg. |
| | | 50/+ | Neg. |
| Wet hotdog | <50 for 3 samples | 100/ND | Pos. |
| 1.5 ml of 15,000 ppm | | 700/+ | Neg. |
| | | 150/ND | Neg. |
| Wet hotdog | <50 for 3 samples | <50/ND | Neg. |
| 1.5 ml of 27,000 ppm | | 50/ND | Pos. |
| | | 50/+ | Neg. |
| Dry hotdog | <50 for 3 samples | <50 for 3 samples/ | Neg. |
| Dipped in 20,000 ppm | | no colonies present | Neg. |
| | | on MOX | Neg. |
| Dry control | 3000 | 1150 | Pos. |
| 2.0 ml propylene | 3550 | 2550 | Pos. |
| glycol | 1400 | 1400 | Pos. |

^{a}Confirmed as L. monocytogenes by BAX ® PCR.
^{b}ND - Not determined.
^{c}Colonies were not black but were tested for L. monocytogenes.

For both dry or wet hotdogs, 2.0 ml of the 20,000 ppm hop beta acid-containing antimicrobial solution resulted in negative USDA enrichments (3 of 3 samples). However, colonies were present on MOX plates for these samples and BAX® PCR confirmed some of these colonies as L. monocytogenes. Therefore, it appears that not all L. monocytogenes was eliminated. Dipping the wieners into the antimicrobial solution resulted in both USDA negative enrichments and no growth on MOX plates. Thus, it appears that the antimicrobial solution containing 20,000 ppm of hop beta acid is capable of eliminating 2.1×10⁴ CFU/package of L. monocytogenes if uniform coverage (i.e., dipping) can be achieved. Moreover, this study suggests that relying on capillary action during vacuum sealing to evenly distribute the antimicrobial solutions may not have provided sufficiently uniform coverage of inoculated wieners.

### EXAMPLE 5.

This examples illustrates the use of the antimicrobial solutions of this invention with sliced Bologna. The antimicrobial solution contained varying levels of hop beta acids (8,900 ppm, 20,000 ppm, or 80,000 ppm), 0.3M lactic acid, and 0.3M potassium lactate and/or 0.1% CPC.

Frozen Bologna slices were dipped into the antimicrobial solutions, placed in plastic packages, inoculated with about 1.6×10⁴ CFU/package of L. monocytogenes and then sealed. In some cases, Blue Dye #1 was added to confirm coverage by the antimicrobial solution. Sealed samples were stored 24 hours at 4° C. and then analyzed for L. monocytogenes. The following samples were used:

| Sample | Solution used | Slices dipped |
|---|---|---|
| 1 | Blue Dye #1 in propylene glycol | One slice |
| 2 | Blue Dye #1 in 20,000 ppm hop beta acid | One slice |
| 3 | 20,000 ppm hop beta acid | One slice |
| 4 | 80,000 ppm hop beta acid | One slice |
| 5 | 8,900 ppm hop beta acid | Two slices |
| 6 | 20,000 ppm hop beta acid | Two slices |
| 7 | 80,000 ppm hop beta acid | Two slices |
| 8 | 0.1% CPC and 80,000 ppm hop beta acid | One slice |
| 9 | 0.1% CPC | One slice |
| 10 | Fat free bologna and 20,000 ppm hop beta acid | One slice |
| 11 | 80,000 ppm hop beta acid (90 min. delay | One slice |
| | between dip and inoculation) | |

The following results (plate counts are average of three trials) were obtained:

| Sample | MOX (CFU/package) | USDA |
|---|---|---|
| 1 | 17500 (1 package <50) | Pos., pos., neg. |
| 2 | 750 | Pos, pos., pos. |
| 3 | 3200 | Pos., pos., pos. |
| 4 | <50 | Neg., pos., pos. |
| 5 | 165 | Pos., pos., pos. |
| 6 | 150 | Neg., pos., pos. |
| 7 | <50 | Neg., neg., neg. |
| 8 | 265 | Pos., pos., pos. |
| 9 | <50 | Pos., pos., pos. |
| 10 | 1150 | Pos., pos., pos. |
| 11 | 4650 | Pos., pos., pos. |

Only sample 7 (dipped in an antimicrobial solution containing the highest level of hop beta acids) effectively eliminated L. monocytogenes. Samples 4 and 9 did reduce plate counts to undetectable levels but also gave positive modified USDA results.

### EXAMPLE 6.

Hotdogs dipped in an antimicrobial solution containing 20,000 ppm hop beta acids, 0.3M potassium lactate, and 0.3% lactic acid in polypropylene glycol were challenged with a six-strain cocktail of L. monocytogenes. The hotdogs were dipped for about 30 seconds in the antimicrobial solution. After allowing the excess to drain, the hotdogs were placed in suitable packaging and inoculated with 2.0×10⁴ CFU/package inoculum, and the package sealed. Sealed samples were stored 24 hours at 4° C. and then analyzed for L. monocytogenes.

The following results were obtained (all plate counts are the average of six samples using three separate inocula):

| | TPC | MOX | |
|---|---|---|---|
| Sample | (CFU/package) | (CFU/package) | USDA |
| 1 | <50 | <50 | 6 of 6 samples negative |
| 2 | <50 | <50 | 6 of 6 samples negative |
| 3 | <50 | <50 | 6 of 6 samples negative |

Dipping hotdogs into the antimicrobial solution successfully eliminated 2.0×10⁴ CFU/package of the six-strain cocktail of L. monocytogenes.

### EXAMPLE 7.

The hops beta acid compositions of this invention are especially useful in a combined thermal surface treatment and antimicrobial treatment method as described in copending application entitled “Method for Controlling Microbial Contamination of a Vacuum-sealed Food Product” filed on the same date as the present invention and which is incorporated by reference.

Listera inoculated (about 10⁴ CFU/package) wieners were treated under various conditions with thermal surface (i.e., steam surface treatment) treatment alone, antimicrobial treatment using the hops acid extract composition as provided in Example 6 above, and combination treatment (i.e., steam surface treatment followed immediately by antimicrobial treatment). Samples were evaluated for Listeria after 24 hours of refrigerated storage. Listeria test methods found in Microbiology Laboratory Guidebook, USDA, 3rd Ed., Chapter 8, Revision 3 (1998), which is hereby incorporated by reference, were used. The following results were obtained.

| | | | | Combined |
|---|---|---|---|---|
| | | | | Thermal |
| | Thermal | Thermal | | Surface |
| | Surface | Surface | Antimicrobial | Treatment (1.5 sec) & |
| | Treatment (3.25 sec) | Treatment (1.5 sec) | Treatment | Antimicrobial |
| | Only | Only | (2.5 g) Only | Treatment (1 g) |
| Number of | 158 | 36 | 69 | 102 |
| Tests | | | | |
| Probability of 4 | 80% | 0% | 45% | 100% |
| log Listeria Kill | | | | |

It will be understood that the embodiments of the present invention which have been described are illustrative of some of the applications of the principles of the present invention. Numerous modifications may be made by those skilled in the art without departing from the true spirit and scope of the invention.

1. A hop beta acid composition comprising a hop beta acid, a first food grade organic acid, a soluble potassium ion source, and an optional antioxidant in a carrier solvent, wherein the carrier solvent comprises a food grade alcohol, a food grade glycol, or mixtures thereof.

2. The hop beta acid composition as defined in claim 1, wherein the composition comprises about 0.1 to about 4 percent of the hop beta acid, about 0.1 to about 10 percent of the first food grade organic acid, about 0.1 to about 20 percent of the soluble potassium ion source, 0 to about 10 percent of the food grade antioxidant, and about 50 to about 95 percent of the carrier solvent.

3. The hop beta acid composition as defined in claim 2, wherein the soluble potassium ion source is a potassium salt of a second food grade organic acid which is soluble in the carrier solvent.

4. The hop beta acid composition as defined in claim 3, wherein the soluble potassium ion source is potassium lactate.

5. The hop beta acid composition as defined in claim 1, wherein the composition comprises about 0.1 to about 4 percent of the hop beta extract, about 0.1 to about 10 percent of the first food grade organic acid, about 4 to about 20 percent of a soluble potassium ion source, about 0.1 to about 10 percent of the food grade antioxidant, and about 50 to about 95 percent of the carrier solvent comprising a food grade alcohol, a food grade glycol, or mixtures thereof.

6. The hop beta acid composition as defined in claim 5, wherein the soluble potassium ion source is a potassium salt of a second food grade organic acid which is soluble in the carrier solvent.

7. The hop beta acid composition as defined in claim 6, wherein the soluble potassium ion source is potassium lactate.

8. The hop beta acid composition as defined in claim 5, wherein the food grade antioxidant is selected from the group consisting of rosemary extracts, carnosic acid, rosmarinic acid, ascorbic acid, propyl gallate, and mixtures thereof.

9. The hop beta acid composition as defined in claim 6, wherein the food grade antioxidant is selected from the group consisting of rosemary extracts, carnosic acid, rosmarinic acid, ascorbic acid, propyl gallate, and mixtures thereof.

10. The hop beta acid composition as defined in claim 7, wherein the food grade antioxidant is selected from the group consisting of rosemary extracts, carnosic acid, rosmarinic acid, ascorbic acid, propyl gallate, and mixtures thereof.

11. A method for inhibiting antimicrobial growth in a food product, said method comprising applying an effective amount of a hop beta acid composition to the food product and sealing the food product and the hop beta acid composition in a package, wherein the hop beta acid composition comprises a hop beta acid, a first food grade organic acid, a soluble potassium ion source, and an optional food grade antioxidant in a carrier solvent, wherein the carrier solvent comprises a food grade alcohol, a food grade glycol, or mixtures thereof.

12. The method of claim 11, wherein the food product susceptible to Listeria monocytogenes activity.

13. The method of claim 12, wherein the food product is a meat food product.

14. The method as defined in claim 11, wherein the hop beta acid composition comprises about 0.1 to about 4 percent of the hop beta acid, about 0.1 to about 10 percent of the first food grade organic acid, about 0.1 to about 20 percent of the soluble potassium ion source, 0 to about 10 percent of the food grade antioxidant, and about 50 to about 95 percent of the carrier solvent.

15. The method as defined in claim 13, wherein the soluble potassium ion source is a potassium salt of a second food grade organic acid which is soluble in the carrier solvent.

16. The method as defined in claim 14, wherein the soluble potassium ion source is potassium lactate.

17. The method as defined in claim 11, wherein the composition comprises about 0.1 to about 4 percent of the hop beta extract, about 0.1 to about 10 percent of the first food grade organic acid, about 4 to about 20 percent of a soluble potassium ion source, about 0.1 to about 10 percent of the food grade antioxidant, and about 50 to about 95 percent of the carrier solvent.

18. The method as defined in claim 17, wherein the soluble potassium ion source is a potassium salt of a second food grade organic acid which is soluble in the carrier solvent.

19. The method as defined in claim 18, wherein the soluble potassium ion source is potassium lactate.

20. The method as defined in claim 17, wherein the food grade antioxidant is selected from the group consisting of rosemary extracts, carnosic acid, rosmarinic acid, ascorbic acid, propyl gallate, and mixtures thereof.

21. The method as defined in claim 18, wherein the food grade antioxidant is selected from the group consisting of rosemary extracts, carnosic acid, rosmarinic acid, ascorbic acid, propyl gallate, and mixtures thereof.

22. The method as defined in claim 19, wherein the food grade antioxidant is selected from the group consisting of rosemary extracts, carnosic acid, rosmarinic acid, ascorbic acid, propyl gallate, and mixtures thereof.

23. A method of imparting improved antibacterial activity to food products, comprising the steps of:
selecting a food product which is susceptible to undesired bacterial activity;
combining a first food grade acid and a soluble potassium ion source with a hop beta acid in a carrier solvent to provide a hop beta acid composition, wherein the carrier solvent comprises a food grade alcohol, a food grade glycol, or mixtures thereof; and
adding the hop beta acid composition to the food product to thereby impart improved antibacterial activity to the food product.

24. The method as defined in claim 23, wherein the food product is susceptible to Listeria monocytogenes activity.

25. The method as defined in claim 24, wherein the food product is a meat food product.

26. The method as defined in claim 25, wherein the hop beta acid composition further comprises an antioxidant.

27. The method as defined in claim 25, wherein the hop beta acid composition comprises about 0.1 to about 4 percent of the hop beta extract, about 0.1 to about 10 percent of the first food grade organic acid, about 4 to about 20 percent of the soluble potassium ion source, about 0.1 to about 10 percent of the food grade antioxidant, and about 50 to about 95 percent of the carrier solvent.

28. The method as defined in claim 27, wherein the soluble potassium ion source is a potassium salt of a second food grade organic acid which is soluble in the carrier solvent.

29. The method as defined in claim 28, wherein the soluble potassium ion source is potassium lactate.

30. The method as defined in claim 27, wherein the food grade antioxidant is selected from the group consisting of rosemary extracts, carnosic acid, rosmarinic acid, ascorbic acid, propyl gallate, and mixtures thereof.

31. The method as defined in claim 28, wherein the food grade antioxidant is selected from the group consisting of rosemary extracts, carnosic acid, rosmarinic acid, ascorbic acid, propyl gallate, and mixtures thereof.

32. The method as defined in claim 29, wherein the food grade antioxidant is selected from the group consisting of rosemary extracts, carnosic acid, rosmarinic acid, ascorbic acid, propyl gallate, and mixtures thereof.
